(19) United States
(12) Patent Application Publication
(10) Pub. No.: US 2023/0056464 A1
(43) Pub. Date: Feb. 23, 2023

(54) ADVANCED WHEELCHAIR

(71) Applicant: PHOENIX INSTINCT LTD, NAIRN (GB)

(72) Inventor: ANDREW MACKAY SLORANCE, NAIRN (GB)

(21) Appl. No.: 17/796,851

(22) PCT Filed: Feb. 1, 2021
(86) PCT No.: PCT/EP2021/052334

§ 371 Date: Aug. 1, 2022

(30) Foreign Application Priority Data
Jan. 31, 2020 (GB) 2001387.6

(51) Int. Cl. A61G 5/02; A61G 5/04

(52) U.S. Cl. CPC A61G 5/02; A61G 5/042; A61G 5/10

(57) ABSTRACT

An advanced manually propelled wheelchair (100) is described. The wheelchair (100) has a chassis (110). In certain examples this may be a single piece design. The wheelchair (100) may further have one or more of a load adjustment mechanism (150) and a power-assist mechanism. The load adjustment mechanism (150) is configured to adjust a position of a set of rear wheels (120) for the wheelchair (100) relative to a loading of the wheelchair (100). Load adjustment may be performed based on a sensed loading. The power-assist mechanism provides a powered torque to a set of front wheels (130) to help a user propel the wheelchair (100) or to stabilise the wheelchair (100) during use. The power-assist mechanism may be provided as a set of modular front wheel units.

### FIELD OF THE INVENTION

This invention pertains generally to the field of wheelchairs. In particular, certain examples relate to manually propelled wheelchairs and component parts for wheelchairs.

### BACKGROUND OF THE INVENTION

Wheelchair design has remained relatively static over the last few decades despite advances in numerous fields of technology. Many manually propelled wheelchairs have a common design: a canvas seat positioned between two lateral rectangular frames, with a set of large rear wheels for manual propulsion and a set of smaller front wheels, often trolley wheels, located near to one or more foot rests that project from the lateral frames. Often, the central canvas seat is collapsible such that the two lateral frames may be folded together for storage. The rear wheels are designed to be gripped by the hands and rotated to drive the wheelchair forward. Portions of the lateral rectangular frames may support a canvas backrest for the seat. These portions may extend into handles to push the wheelchair from behind.

Inertia and cost pressures within the healthcare sector have led to the calcification of the above common design. This is despite complaint from wheelchair users. For example, the above common design is often bulky and unwieldy, requiring much effort from a wheelchair user to move themselves around. The design is also often reported to be uncomfortable and inflexible.

JP2009172082A describes a variation of the above common design, whereby one of a set of front trolley wheels is swapped for a drive unit. The drive unit provides powered motion for one of the front wheels. An on/off switch is provided to active the drive unit. A similar design is described in CN2522058YA. JP2006081849A describes a wheelchair that has a powered auxiliary wheel that is located between a set of front wheels; when the auxiliary wheel is engaged, the front wheels are lifted off the ground such that only the auxiliary wheel is used. While the variations these designs present are appreciated by wheelchair users, they are still relatively impractical. For example, they are often difficult to control in practice.

Complex, powered, self-balancing wheelchairs have been suggested to overcome some of the shortcomings of conventional wheelchair design. US6311794B1 provides an example of the iBOT design. This design featured a plurality of smaller rear wheels on each side (four at the rear in total) for powered propulsion. The seat of the wheelchair is able to balance on a pair of rear wheels. It was not designed for manual propulsion. This provided the inspiration for the design of the non-medical two-wheeled Segway device. However, the complex control meant that the wheelchair was too expensive and unpredictable, which led to low demand from wheelchair users.

### PROBLEM TO BE SOLVED BY THE INVENTION

There is thus a need for improvements in wheelchair design that are centred around the needs of the majority of wheelchair users. For example, it is an object of the invention to provide a wheelchair that may be manufactured for an affordable price, and that improves the ease with which a wheelchair use may navigate their environment.

Powered wheelchairs such as those described in US6311794B1 are too expensive and too heavy and bulky to be of use to the majority of wheelchair users. The conventional manually propelled wheelchair design (as featured in JP2009172082A, CN2522058YA, and JP2006081849A) is cheaper and easier to transport but it is still difficult for users to manually manoeuvre. Despite advances in the design of urban infrastructure, it is still unfortunately the case that a large number of urban environments are difficult for wheelchair users to access. This issue is compounded for manually propelled wheelchairs as manoeuvrability further relies on the upper body strength of a user. It is thus desired to provide a wheelchair that is highly manoeuvrable but that reduces the strain on the user. For example, there is a desire to reduce injuries and joint damage from long term pushing of a wheelchair. Active wheelchair users also typically desire a lightweight portable device not a heavy electric chair.

### SUMMARY OF THE INVENTION

In accordance with a first aspect of the invention, there is provided a manually propelled wheelchair comprising: a chassis to accommodate a seat; a set (preferably a pair) of rear wheels for manual propulsion arranged either side of the chassis; a set (preferably a pair) of front wheels; one or more sensors to detect a loading (and/or location of centre of gravity) of the wheelchair; and a load adjustment mechanism to adjust a position of the set of rear wheels relative to the seat (and/or the chassis) in response to signals from the one or more sensors.

In a second aspect of the invention, there is provided a method of operating a manually propelled wheelchair comprising: sensing a change in a centre of gravity for the wheelchair at least along an axis between a set of front wheels and a set of rear wheels, wherein the set of rear wheels are manually propelled to move the wheelchair; and adjusting a relative position of the set of rear wheels compared to a seat of the wheelchair based on the change, the seat being configured to receive a load for the wheelchair.

In a third aspect of the invention, there is provided a manually propelled wheelchair comprising: a chassis to accommodate a seat; a pair of rear wheels for manual propulsion arranged either side of the chassis; a pair of front wheels; and a drive system for the pair of front wheels, wherein the drive system comprises at least one motor coupled to the pair of front wheels, and wherein a torque applied to one or more of the set of front wheels by the at least one motor at least assists the propulsion of the wheelchair.

In a fourth aspect of the invention, there is provided a front wheel unit for a wheelchair comprising: a wheel mounting; a mechanical interface for mechanically coupling the front wheel unit to the wheelchair; a front wheel within the wheel mounting; a motor within the front wheel to rotate the front wheel about an axis of the front wheel to at least assist in propelling the wheelchair; a load sensor to sense a load applied to the front wheel; and an electrical interface for electrically coupling the load sensor to a control system of the wheelchair, wherein an angle of attack for the front wheel is variable with respect to the wheelchair.

In a fifth aspect of the invention, there is provided a single-piece wheelchair chassis comprising: a front frame portion for use as a footrest and for coupling a set of front wheels; two side frame portions for coupling a set of rear wheels; and a rear frame portion for use as a back support.

In a sixth aspect of the invention, there is provided a manually propelled wheelchair comprising: a single-piece wheelchair chassis; a pair of rear wheels for manual propulsion arranged either side of the wheelchair chassis; a pair of front wheel units, each front wheel unit comprising: a wheel mounting; a front wheel within the wheel mounting; a motor to rotate the front wheel about an axis of the front wheel to at least assist in propelling the wheelchair, and a load sensor to sense a load applied to the front wheel; and a load adjustment mechanism to adjust the position of one or more axles for the pair of rear wheels relative to the wheelchair chassis in response to signals from one or more of the load sensors.

In a seventh aspect of the invention, there is provided a control system for a manually propelled wheelchair comprising: a sensor interface to receive signals from one or more sensors arranged to detect a loading of the wheelchair with respect to at least one of a set of front wheels and a set of rear wheels; a load adjustment interface to instruct a load adjustment mechanism to move one or more of a load within the wheelchair and the set of rear wheels relative to a chassis of the wheelchair; and a controller coupled to the sensor interface and the load adjustment interface to align the set of rear wheels with the centre of gravity for the wheelchair by instructing the load adjustment mechanism.

In an eighth aspect of the invention, there is provided a wheel push rim for a wheelchair, the wheel push rim having a laterally disposed portion which defines a generally smooth circular form for the push rim thereby allowing the user to allow the rim to run smoothly through their hand while free-wheeling and a medially disposed outer portion for receiving the palm or heal of the hand by which the rim is used to propel the wheelchair, the medially disposed outer portion characterised by a surface that is shaped to enhance the force applicable and/or comfort of the palm/heal when propelling the wheelchair with the rims, the surface defining a plurality of flattened or recessed surface areas (relative to a maximum outer perimeter of the rim) disposed about circumference of rim and/or flattened and/or inclined surface portions (inclined relative a tangent to a maximum outer perimeter of a rim, so as to enhance propulsion force).

In a ninth aspect of the invention, there is provided a front wheel unit arrangement for a wheelchair comprising: a wheel mounting; a mechanical interface for mechanically coupling the front wheel unit to a wheelchair; a front wheel within the wheel mounting; a motor within the front wheel to rotate the front wheel about an axis of the front wheel to at least assist in propelling the wheelchair; and a controller for the motor, wherein the motor is a torque producing device and the wheels are torque driven, the motor is configured to provide variable torque or a torque according to one, two, three or more pre-defined settings defining ranges of torque, wherei the controller is configured with a user control switch or interface to select a variable torque or a pre-defined torque setting, and wherein an angle of attack for the front wheel is variable with respect to the wheelchair.

### ADVANTAGES OF THE INVENTION

A first aspect of the present invention provides a manually propelled wheelchair, i.e. a wheelchair where the rear wheels are primarily propelled by hand, with sensors to detect a loading of the wheelchair and a load adjustment mechanism to adjust a position of the set of rear wheels relative to the seat in response to signals from the sensors. Here, a user may still use their hands to propel the rear wheels, but the position of the set of rear wheels relative to the seat, and so in turn the user, may be moved to enable easier propulsion and increased manoeuvrability. The wheelchair may be produced for a relative low cost as compared to complex powered wheelchair designs, yet also has advantages over conventional manually propelled wheelchair designs for a user. The one or more sensors may detect how much weight is being loaded onto the front wheels and a control system may then align this weight with a pre-determined amount by moving a rear wheel axle position. This allows the front of the wheelchair to remain light, so the wheelchair is easy to push and turn without falling backwards.

A second aspect provides a method with similar advantages.

A third aspect of the present invention provides a manually propelled wheelchair with a drive system for a pair of front wheels, wherein a torque applied to the front wheels by at least one motor of the drive system at least assists the propulsion of the wheelchair. In this aspect, a power-assist mechanism may be provided to complement the manual propulsion of the wheelchair using the hands. For example, a user may still propel the wheelchair by rotating the rim of the rear wheels by hand, but the motor coupled to front wheels may take some of the load to ease the burden on the wheelchair user. The power-assist functionality may be of benefit when navigating difficult environments, such as steep inclines (as found with ramps and the like). It may also be used to ease the burden on the user for longer distances and/or periods of tiredness . The power-assist functionality may further be used to provide a powered braking function when descending an incline and/or to allow for remote control of the wheelchair. In the latter case, the power-assist functionality may be configured to allow a user to steer the wheelchair towards them when they are absent from the seat (e.g. when getting up from a seat or bed). This provides greater independence for the wheelchair user.

A fourth aspect of the present invention provides a front wheel unit for implementing the above-referenced third aspect. The front wheel unit may be provided as an optional upgrade for a manually propelled wheelchair. This reduces a cost of a base wheelchair and also allows the power-assist functionality to be modularly switched in and out depending on requirements. The front wheel unit may be rotatable with respect to the wheelchair to allow the wheelchair to be steered in different directions, e.g. an attack angle of the wheels may be controlled to steer the wheelchair. Steering may be provided by differentially powering the motors of a pair of front wheel units. This can enhance the remote-control function discussed above.

A fifth aspect of the present invention provides a single-piece chassis for a wheelchair. Providing the chassis as a single piece increases robustness as stresses may be distributed throughout the chassis which avoids failure at the bonding points of a multiple-piece frame. A single piece chassis is also better able to experience controlled elastic deformation. Use of composite materials or carbon fibre as a single piece also facilitates manufacture and makes the wheelchair lightweight and manoeuvrable.

In a sixth aspect of the present invention, the first to fifth aspects may be combined for synergistic effect. For example, a lightweight chassis enhances the power assist functionality of the front wheels by reducing the load due to the wheelchair (e.g. as opposed to the user) and further enhances manoeuvrability while in a remote-control mode. The load adjustment mechanism may further control the loading on the front wheels, which can favourably control the friction conditions for the power assist mode. Additionally, a lightweight single piece frame increases the effect of adjusting either the rear wheel or seat position, as the weight of the user is a higher proportion of the weight of the wheelchair in use.

In a seventh aspect of the present invention there is a control system for use in implementing one or more of the first and sixth aspects. The control system may form part of a retrofit kit for an existing manually propelled wheelchair to provide the advantages discussed herein.

### BRIEF DESCRIPTION OF THE DRAWINGS

FIG. 1A is a schematic side view of a wheelchair according to an example.

FIG. 1B is a cut-away version of FIG. 1A that illustrates certain components not visible in FIG. 1A.

FIG. 1C is a schematic front view of the wheelchair of FIGS. 1A and 1B.

FIG. 1D is a cut-away version of FIG. 1C that better illustrates certain components shown in FIG. 1C.

FIGS. 2A to 2C are schematic side views of an example wheelchair showing different adjustments of a rear wheel position for different loading configurations.

FIGS. 3A to 3C are schematic side views of an example wheelchair showing different adjustments of a seat position for different loading configurations.

FIGS. 4A and 4B are system diagrams showing different configurations of an example controller for a wheelchair.

FIG. 5 is a schematic side view of an example wheelchair that illustrates the use of an orientation sensor.

FIG. 6A is a schematic front view of an example front wheel unit.

FIG. 6B is a cut-away version of FIG. 6A.

FIG. 7 is a flow diagram showing an example method of operating a manually propelled wheelchair.

FIG. 8A is a front view of an example wheelchair chassis.

FIG. 8B is a side view of the example wheelchair chassis of FIG. 8A.

FIG. 9 is a side view of an example wheelchair.

FIG. 10A is a side view of an example chassis for a wheelchair with certain features removed for improved visibility.

FIG. 10B is a side view of a load adjustment mechanism according to an example.

FIG. 11A is a perspective view of a wheel rim according to an example.

FIG. 11B is a close-up perspective view of a portion of the wheel rim of FIG. 11A.

### DETAILED DESCRIPTION OF THE INVENTION

The invention is concerned with an advanced wheelchair that provides many advantages over conventional wheelchair configurations. Certain examples of the invention (hereafter simply “examples”) relate to a manually propelled wheelchair that is designed to be propelled (i.e. moved) through the action of the user’s hands on a rim of a set of rear wheels of the wheelchair.

The term “wheelchair” as used herein relates to any wheeled transport device for a human being and preferably a device in which the human being is transported in a substantially sitting position, e.g. with the upper portion of the legs at an angle (e.g. near 90 degrees) to the torso. A wheelchair may be used when a user has a reduced or limited ability to move their legs to walk upright.

The term “manually propelled” refers to a wheelchair that is primarily moved by the user when seated in the wheelchair, e.g. as compared to powered wheelchairs where the wheelchair is propelled independently of the user. However, as shown by examples herein, the term need not exclude other forms of secondary propulsion and/or powered propulsion when the user is absent from the wheelchair. In certain cases, the secondary propulsion method may primarily propel the wheelchair for limited time periods; however, the secondary propulsion method is not configured to propel the wheelchair independently to the exclusion of manual propulsion, and the wheelchair is configured such that the user is able to propel the wheelchair when seated even if the secondary propulsion method is off or not functional.

Certain examples described herein cover different aspects of an advanced wheelchair that may be used separately or in combination . Different aspects may be used in any combination of two or more aspects As described later with respect to the specific examples below, certain combinations provide synergistic benefits over and above the individual benefits of each aspect.

Examples of the invention will now be described in more detail, without limitation, with reference to the accompanying Figures.

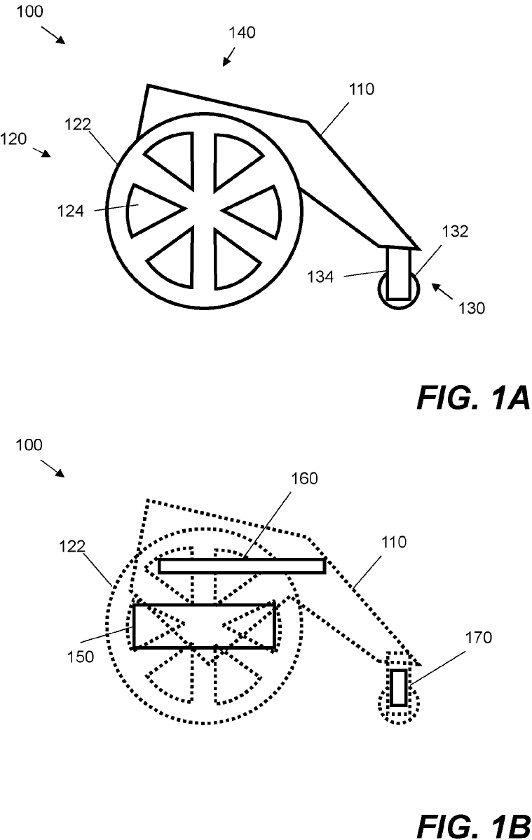

FIGS. 1A to 1D show a particular example of a wheelchair 100 that combines multiple aspects of the invention. Although the example shows a preferred configuration of the wheelchair, it is to be understood that differing configurations are possible For example, other implementations may only implement a limited number of aspects, e.g. fewer aspects than shown. Also, certain aspects may also be used with wheelchair designs other than those shown in the Figures, including the examples of the comparative “common design” discussed in the background.

FIG. 1A shows a side view of the wheelchair 100. The wheelchair 100 comprises a chassis 110, a set of rear wheels 120 and a set of front wheels 130. The set of rear wheels 120 comprise a pair of rear wheels that are laterally spaced either side of the chassis 110. The set of rear wheels 120 are larger than the set of front wheels 130.

In the example of FIGS. 1A to 1D, the height of the rear wheels is configured to allow a user to sit within the chassis 110 with their feet located above the set of front wheels 130. Users that are different heights may maintain the same “ride height” by varying a height of the chassis 110 relative to the set of rear wheels 120, e.g. the set of rear wheels typically has a predefined height and the frame of the wheelchair may be mounted higher or lower on the wheels for different users. In FIG. 1A, the chassis 110 accommodates a seat 140. The seat 140 may be formed between the lateral sides of the chassis 110 and the rear of the chassis 110, e.g. as shown in more detail in FIGS. 1C and 1D. A rear wheel in the set of rear wheels 120 in this example comprises a rim 122 and a user present in the seat 140 may propel the wheelchair 100 forwards and backwards by rotating the set of rear wheels 120 forwards and backwards using the rim 122 (or portions of the wheel around the rim). In certain cases, the rear wheels may comprise a handle portion to facilitate propulsion. In certain cases, the set of rear wheels 120 may be removable and/or replaceable. The rear wheels in the present example comprise cut-out portions 124 that are formed between spokes of the wheel, but different wheel designs are possible.

The set of front wheels 130 comprise a wheel portion 132 and a wheel mounting 134. The wheel mounting 134 may comprise a wheel frame within which the wheel portion 132 is rotatably mounted. The wheel mounting 134 may comprise a fork or the like. The wheel mounting 134 is mechanically coupled to the chassis 110 in the present example. In certain cases, the wheel mounting 134 may be rotatably mounted to the chassis 110 such that an angle of attack for at least the wheel portion 132 may vary. For example, the set of front wheels 130 may comprise trolley wheels, wherein the angle of the wheel portion 132 about a substantially vertical axis is variable to help steer the wheelchair 100 together with differential action of the user’s hands on the set of rear wheels 120.

FIG. 1B shows a cut-away version of the side view of FIG. 1A that shows certain additional components. In this example, the set of rear wheels 120 are coupled to a load adjustment mechanism 150. The load adjustment mechanism 150 is configured to adjust a position of the set of rear wheels 120 relative to the seat 140, i.e. relative to a sitting position of a user. The load adjustment mechanism 150 is located behind the rear wheel shown in FIG. 1A and may provide a coupling between the set of rear wheels 120 and the chassis 110.

FIG. 1B also shows a platform 160 that may be used to form the seat 140. The platform 160 may comprise a rigid platform, e.g. as constructed from a set of rigid elongate members that span a space between the two lateral sides of the chassis 110, or a deformable platform, e.g. as constructed from fabric portions that span the same space. Although examples described herein refer to a platform and a cushion forming a seat, only one of these may be provided in other examples, and different seat designs are envisaged.

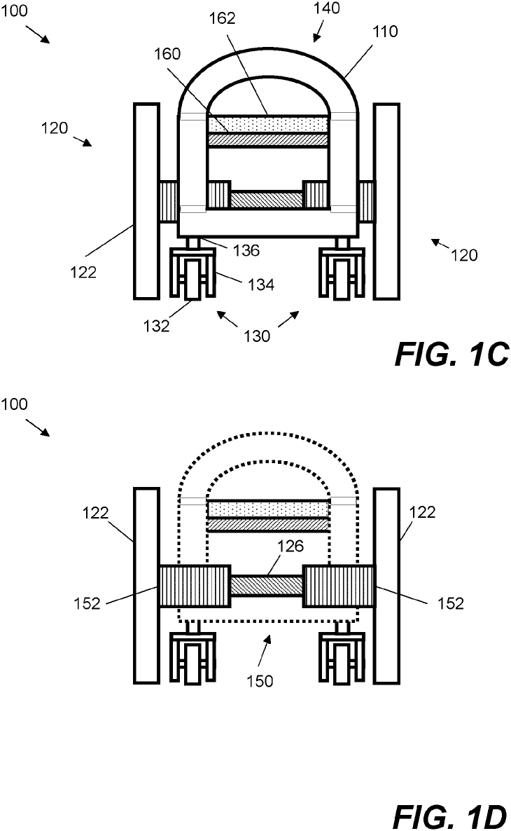

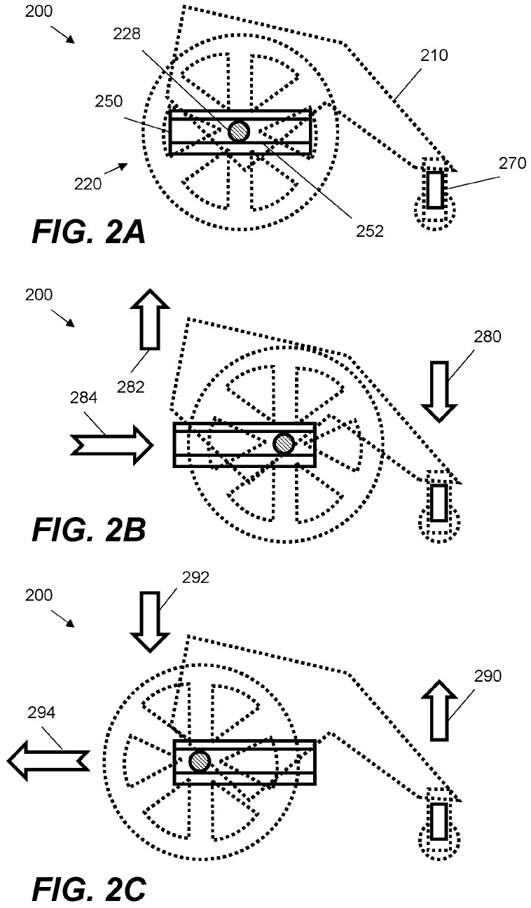

Lastly, FIG. 1B shows a load sensor 170 to detect a loading of the wheelchair 100. The loading may be used to modify a distance of a centre of gravity for the wheelchair (e.g. a weight of the user and/or a weight of the wheelchair) with respect to the set of rear wheels 120. In this example, the load sensor 170 is installed within the wheel mounting 134 of the set of front wheels 130. A load sensor 170 may be provided in one or both of a pair of wheel mountings 134 for the front wheels. The load sensor 170 is electrically coupled to a control system of the wheelchair 100. The signal from the load sensor 170 is used to determine a loading on the set of front wheels 130. In certain examples, this may be used as an indication of a position of a centre of gravity of the wheelchair at least along an axis between the set of front wheels 130 and the set of rear wheels 120 (e.g. the front-back horizontal axis of FIG. 1B). A signal or set of signals from the load sensor 170 is used to detect a loading so as to control the load adjustment mechanism 150. The load adjustment mechanism 150 adjusts the relative position of the set of rear wheels 120 with respect to the seat 140. The adjustment may be made to stabilise the wheelchair 100. Examples of this adjustment are provided in FIGS. 2A to 2C and 3A to 3C.

FIG. 1C is a front view of the wheelchair 100. The set of rear wheels 120 are visible either side of the chassis 110. FIG. 1C shows how a seat 140 may be formed within the chassis 110. The platform 160 shown in FIG. 1B is visible spanning the two lateral sides of the chassis 110. In FIG. 1C, a removable cushion 162 is placed on the platform 160 to form the seat 140. A user may sit on the cushion 162 and rest their lower back against the rear portion of the chassis 110. In certain cases, the rear portion of the chassis 110 may be additionally extended by an insertable removable back support.

The wheel portion 132 and the wheel mounting 134 that form part of one of the set of front wheels 130 are further visible in FIG. 1C. The wheel mounting 134 comprises a wheel frame that is mechanically coupled to the chassis 110 at coupling 136. The wheel mounting 134 may be configured to rotate about the coupling 136. The wheel mounting 134 may comprise a castor fork. A similar arrangement is provided for the other front wheel. In one case, the chassis 110 may comprise an aperture to accommodate and fasten a portion of the wheel mounting 134. In another case, the wheel mounting 134 may be clamped to the chassis 110. Different coupling arrangements may be used.

In the present example, the chassis 110 is formed as a single piece. The chassis 110 may comprise a lightweight material, such as one or more of carbon fibre, graphene, polymer or polymer compounds, and composite materials. The lower front portion of the chassis 110 may form a footrest for the user while seated.

FIG. 1D shows the load adjustment mechanism 150 in more detail. In this example, the set of rear wheels 120 are coupled by a frame member 126. The frame member 126 spans the space between the pair of rear wheels underneath the seat. The frame member 126 fixes each rear wheel with respect to each other such that any relative movement of one wheel is also applied to the other wheel. Although the frame member 126 is shown in this example, in other examples the frame member 126 may be omitted and a relative position of each of the set of rear wheels 120 may be independently adjusted, e.g. each rear wheel may have a separate independent axle without an intermediate coupling member. In another case, each rear wheel may comprise a separate axle that is allowed to freely rotate within the frame member 126.

In the example of FIG. 1D, the load adjustment mechanism 150 comprises a set of actuators 152, where one actuator is provided for each rear wheel. The actuators 152 adjust a position of the frame member 126 and set of rear wheels 120 with respect to the chassis 100. This is shown in more detail in FIGS. 2A to 2C. In one case, each rear wheel 120 may comprise an axle for rotation of the wheel. In another case, a single axle for both rear wheels 120 may be provided. In this case, the axle may be a single elongate member and/or allow for differential movement of the rear wheels 120 (e.g. to rotate the wheelchair 120). If each rear wheel 120 has an independent axle, these may allow for each rear wheel to rotate independently to rotate the wheelchair 120. In this case, the actuators 152 may be controlled in tandem or may be controlled separately. Multiple rear wheel configurations are possible.

FIGS. 2A to 2C show how a load sensor 270 and a load adjustment mechanism 250 may be used to determine a loading for a wheelchair 200 and in turn adjust a relative position of a rear wheel 220 with respect to a chassis 210 of the wheelchair 200. The operations shown in FIGS. 2A to 2C are preferably mirrored by a similar set of components on the other side of the wheelchair 200, but in certain cases may be performed for a single rear wheel or each rear wheel of a pair independently. In a case, where the rear wheels are coupled by a frame member such as the frame member 126 in FIG. 1D this may constrain both rear wheels in a pair to move in a co-ordinated manner.

FIGS. 2A to 2C show a cut-away version of a side view of the wheelchair 200 that is similar to FIG. 1B. The wheelchair 200 may be the wheelchair 100 of FIGS. 1A to 1D or a variation of this wheelchair. In this example, the load adjustment mechanism 250 adjusts a position of the rear wheel 220 by moving a position of an axle 228 for the rear wheel 220. The axle 228 may extend into a frame member such as frame member 126 in FIG. 1D or may only extend partially into an actuator such as actuators 152 shown in FIG. 1D. In the present example, the load adjustment mechanism 250 comprises a linear actuator 252, which may implement the actuator 152 of FIG. 1D. The linear actuator 252 is configured to move the axle 228 with respect to the chassis 210, and so in turn with respect to a seat that is fixably formed within the chassis 210.

FIGS. 2A to 2C show how the linear actuator 252 may be configured to move the axle 228 of the rear wheel 220 in one or more directions based on sensor signals from the load sensor 270. FIG. 2A shows a default location for the axle 228. In the present example, the default location is a central location within the linear actuator 252. In other implementations, the default location may comprise a different location (e.g. one of the forward or back extreme positions). FIG. 2B shows a movement of the axle 228 in a forward direction towards the set of front wheels. FIG. 2C shows a movement of the axle 228 in a backward direction towards the rear of the wheelchair. Although FIGS. 2B and 2C show movement in two opposing directions from a central position, in other implementations the default position may comprise one or the positions shown in FIGS. 2B and 2C and the movement may be to the other of the positions shown in FIGS. 2B and 2C. Different variations of linear movement are possible. Additionally, although the movement is shown as substantially horizontal in the Figures, in certain examples the movement may involve movement at an angle to the horizontal.

FIG. 2B shows a movement that may be performed on detection of an increased load on the set of front wheels. This is indicated by arrow 280. An increased load may be experienced if a user moves or leans forwards in the wheelchair 200. An increased load may also be experienced if a load is removed from a rear of the wheelchair 200 as indicated by arrow 282. For example, a bag may be removed from the rear of the wheelchair 200 or a helper may remove an additional pushing force from the rear. Any combination of load changes may be experienced that are then detected by a change in the signal from the load sensor 270.

Given the change in the signal from the load sensor 270 that indicates an increased load on the front wheels, the load adjustment mechanism 250 is configured to use the linear actuator 252 to move the axle 228 forwards as shown by arrow 284. This then reduces a load on the front wheels. For example, a load on the front wheels may be reduced by around 80%. Reducing the load on the front wheels by moving the rear wheels 220 may be seen as better aligning the rear wheel 220 with a centre of gravity of the wheelchair 200. The centre of gravity may reflect a weight of the wheelchair 200 and a weight of a user, or just the weight of the wheelchair 200 for a remote control mode that is explained with respect to later examples. The better alignment allows for greater stability, preventing the wheelchair 200 from toppling and allowing a user to more easily propel the wheelchair 200. For example, FIG. 2B may represent a case where the user leans forward to propel the wheelchair 200 at an increased speed. This may add weight to the front wheels and so increase drag. By reducing the load on the front wheels this drag may also be reduced making the wheelchair easier to propel. This adaptability may improve manoeuvrability in urban environments.

FIG. 2C shows a movement that may be performed on detection of a decreased load on the set of front wheels. This is indicated by arrow 290. A decreased load may be experienced if a user moves or leans backwards in the wheelchair 200. A decreased load may also be experienced if a load is added to the rear of the wheelchair 200 as indicated by arrow 292. For example, a bag may be added to the rear of the wheelchair 200 or a helper may begin applying an additional pushing force from the rear. Any combination of load changes may be experienced that are then detected by a change in the signal from the load sensor 270. Too little load on the front wheels may make the wheelchair unstable, e.g. the wheelchair may be prone to topple backwards. If the set of rear wheels are too far forward and a user leans back in the wheelchair, then this can cause a comparative wheelchair to tip over backwards.

In the example of FIG. 2C, given the change in the signal from the load sensor 270 that indicates a decreased load on the front wheels, the load adjustment mechanism 250 is configured to use the linear actuator 252 to move the axle 228 backwards as shown by arrow 294. This then increases a load on the front wheels. This can also be seen as better aligning the rear wheel 220 with the centre of gravity of the wheelchair 200. As above, the better alignment allows for greater stability, preventing the wheelchair 200 from toppling backwards and allowing a user to more easily propel the wheelchair 200. For example, FIG. 2C may represent a case where the user leans backward to push, e.g. as leaning on the backrest may help give a platform to rest against for stronger pushing if the user’s core body is not very strong. However, leaning back this way can result in the front wheels lifting off the ground which means the user can’t push strongly as they may fall over backwards and/or the user may be at risk of falling back when they come to a slope. Without the load adjustment mechanism 250 actions such as these may destabilise the wheelchair 200. However, with the movement of the axle 228 shown in FIG. 2C, stability may be maintained. Moving the rear wheels 230 rearward may allow a user to go up a slope while leaning back and push strongly without the front wheels lifting. Also, moving the rear wheels rearward may increase the loading on the front wheels, which in turn increases the friction between the wheels and the ground improving braking and steering. Again, this adaptability may improve manoeuvrability in urban environments.

In the example of FIGS. 2A to 2C, the steering of the wheelchair 200 may become heavy when weight is added to the front wheels. To avoid this and improve manoeuvrability, the loading on the front wheels may be controlled to maintain a predefined “light” loading. With a reduced loading on the front wheels, steering may become more responsive and the wheelchair 200 may become easier to push and turn. As such, the rear wheels may be moved forward, such as is shown in the case of FIG. 2B, to provide easier pushing, less vibration, and easier turning. The rear wheels may be moved backward, e.g. to put weight on the front wheels, to improve grip (e.g. when using powered front wheels as described below) and to provide better rearward stability.

A wheelchair user may configure a desired centre of gravity based on their own preferences. For example, a user may test drive a wheelchair where different loading patterns are experienced. They may choose a loading pattern that they find easiest to use (e.g. looking at a trade-off between stability and manoeuvrability). The selected loading pattern may be entered as a configuration setting into the wheelchair control system. The loading pattern may translate into a predefined loading to maintain on the set of front wheels. In practice, a predefined loading for the front wheels is typically selected that is just shy of the chair tipping back, and the load adjustment mechanism maintains this loading. Having the active load adjustment mechanism allows a light front loading to be maintained while avoiding the risk of tipping backwards. The present examples thus provide a wheelchair that is easy to move and has maximum stability.

In FIGS. 2A to 2C, an axle 228 of the rear wheel 220 is moved in opposite directions based on a determined loading of the wheelchair. This keeps the rear wheel 220 better aligned with the centre of gravity of the wheelchair. Each rear wheel in a pair of rear wheels may be moved in this manner independently or, preferably, the movement of each rear wheel in the pair of rear wheels may be co-ordinated. In a case where the pair of rear wheels are coupled by a common or shared rear axle then one or more linear actuators may move that axle. In a case where each rear wheel has an independently moveable axle, then two linear actuators may be provided (e.g. one on each side). In this case, for stability, the movement performed by each linear actuator may be co-ordinated electronically (e.g. each linear actuator may be provided with a common or shared set of displacement instructions or signals) . The axle 228 for a given rear wheel 220 may be mounted within a bearing or low-friction aperture such that an outer mounting of the axle 228 may be moved linearly while still allowing the axle 228 to rotate to propel the wheelchair backwards and forwards using the rear wheels.

It should be noted that some comparative wheelchairs allow manual adjustment of the position of the rear wheels. However, like bicycle wheels, this typically involves loosening a wheel nut, sliding a rear wheel axle along in a slot or elongate aperture before fastening the wheel nut such that the wheel is located in a new position. In contrast to this approach, the present examples seek to adjust a position of one or more rear axles without manual effort and during use (e.g. propulsion) of the wheelchair. In these comparative cases, the rear wheels are not adjusted while the user is sat in the wheelchair in response to the user’s actions; indeed, this is generally discouraged as it would pose a safety risk with comparative rear wheel mountings.

FIGS. 3A to 3C show an alternative example that be may used as well as, or instead of, the example of FIGS. 2A to 2C. In FIGS. 3A to 3C, a load adjustment mechanism 350 is provided that adjusts a position of the seat, e.g. seat 140, to recalibrate a loading on the wheelchair 300. In the example of FIGS. 3A to 3C, the rear wheels 320 are fixably coupled to the chassis 310, i.e. they do not move backwards and forwards. However, in other examples, the rear wheels 320 may be moved as well using the approach described in the previous example.

In FIGS. 3A to 3C, the load adjustment mechanism 350 is configured to adjust a position of a platform 360 that forms a basis for the seat of the wheelchair 300. The platform 360 may be similar to the platform 160 described with reference to FIGS. 1B to 1D. In FIGS. 3A to 3C, the lateral sides of the platform 360 are mounted within a groove or aperture 366 that enables substantially horizontal movement of the platform 360 with respect to the chassis 310. Similar to the example of FIGS. 2A to 2C, a linear actuator 352 is provided to move lateral portions 366 of the platform 360. In FIG. 3A these lateral portions 366 are shown as lateral pins of the platform 360 but they may have other forms (e.g. may have any of the linear actuators forms known or discussed herein). The lateral portions 366 are moveable by the linear actuator 352 to move the platform forwards and backwards.

FIG. 3B shows a movement of the platform 360 that may be performed on detection of an increased load on the set of front wheels. This is indicated by arrows 380 and 382. The load changes are detected by a change in the signal from the load sensor 370. Given a change in the signal from the load sensor 370 that indicates an increased load on the front wheels, the load adjustment mechanism 350 is configured to use the linear actuator 352 to move the lateral portions 366 backwards as shown by arrow 384. This in turn moves the platform 360 and the position of the seat. This then reduces a load on the front wheels, e.g. to maintain a predefined desired loading.

Likewise, FIG. 3C shows a movement of the platform 360 that may be performed on detection of a decreased load on the set of front wheels, e.g. similar to the case of FIG. 2C. The change in load is indicated by arrows 390 and 392, and is detected via a changing signal the load sensor 370. In this case, the load adjustment mechanism 350 is configured to use the linear actuator 352 to move the lateral portions 366 forwards as shown by arrow 394. This in turn moves the platform 360 and the position of the seat. This then increases a load on the front wheels, e.g. to maintain a predefined desired front wheel loading.

In both the examples of FIGS. 2A to 2C and FIGS. 3A to 3C, a load adjustment mechanism is used to adjust the position of the rear wheels relative to the seat. This in turn adjusts the position of the rear wheels with respect to a centre of gravity of the wheelchair and improves stability and manoeuvrability. For example, to reduce the work performed for a user of the wheelchair it is desired to reduce the weight that is applied to the front wheels; however, a centre of gravity needs to be carefully balanced to prevent the wheelchair tipping over. By suitably calibrating the load sensor and the load adjustment mechanism this may be achieved.

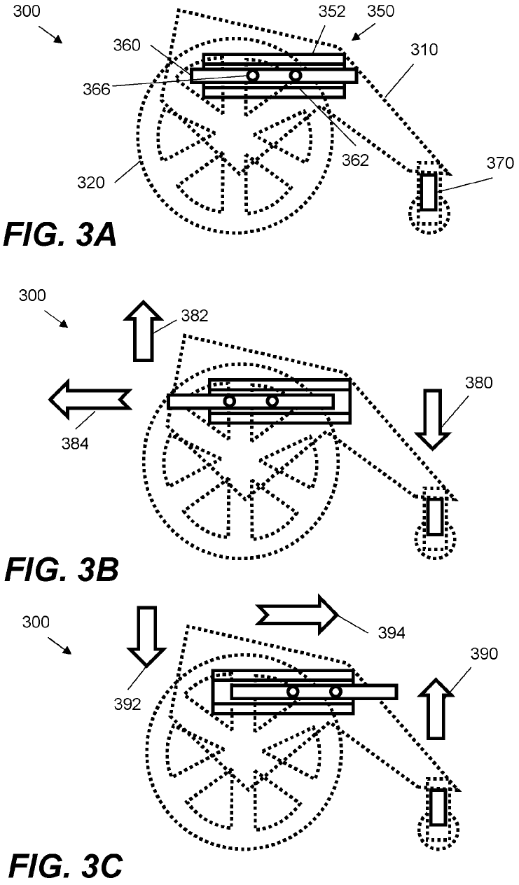

FIGS. 4A and 4B show two examples of a control system 400, 402 that may be used to adjust the position of the rear wheels with respect to a centre of gravity of a wheelchair. Either of the control systems 400, 402 may form part of an electronic control system for the wheelchair of the previous examples.

FIG. 4A shows a first control system 400 comprising a controller 410, a load sensor 420, and a load adjustment mechanism 430. The controller 410 receives signals from the load sensor 420 and instructs the load adjustment mechanism 430 to make an adjustment to the position of the set of rear wheels relative to the seat, e.g. as shown in one or more of FIGS. 2A to 3C. The load sensor 420 may comprise a sensor located at a front of the wheelchair, e.g. within the wheel mounting 134. The load sensor 420 may comprise one or more of the load sensors 170, 270 and 370 as described in the previous examples. In other cases, the load sensor 420 may comprise a different sensor, such as one of a set of pressure sensors arranged relative to the seat to detect a load applied to the seat. These pressure sensors may be located, for example, within the platform 160 or 360, on top or below this platform, or within a cushion such as cushion 162 (with suitable electrical coupling if the cushion is removable).

The controller 410 may comprise a microcontroller or embedded processor (e.g. a central processing unit). The controller 410 may be mounted under the platform or seat, at the rear of the wheelchair, or coupled to one of the sides of the wheelchair. In FIG. 4A, the controller 410 comprises a sensor interface 412 to receive signals from the load sensor 420 If the load sensor 420 is positioned within a wheel mounting of a removable front wheel unit, the load sensor 420 may be plugged into a communications bus or other electrical coupling to allow sensor signals to be received at the sensor interface 412. The sensor signals may be digital or analogue sensor signals. In one case, the sensor signals may comprise a voltage level that changes according to a load applied to (or through) the load sensor 420. In another case, the sensor signals may comprise a digital value indicative of an amount of loading, e.g. an 8 or 16 bit signed or unsigned integer value. The load sensor 420 may be calibrated based on a loaded or unloaded wheelchair. The signals from the load sensor 420 are useable to detect a loading of the wheelchair. In certain, more complex examples, the load sensor 420 may be used to determine a position of a centre of gravity at least along an axis between a set of front wheels and a set of rear wheels. By an axis between a set of front wheels and a set of back wheels, it is preferably mean an axis that bisects a pair of front wheels and a pair of back wheels and preferably corresponds to a front-back direction of the wheelchair, e.g. falling within a plane of general symmetry of the wheelchair. For example, an increase in loading as reflected in a change in the sensor signal in a first direction may indicate that a centre of gravity has shifted forward from a comparative position and a decrease in loading as reflected in a change in the sensor signal in a second, opposite direction may indicate that a centre of gravity has shifted backward from the same comparative position.

The controller 410 also comprises a load adjustment interface 414 to instruct a load adjustment mechanism 430 to move one or more of a load within the wheelchair and the set of rear wheels relative to a chassis of the wheelchair. For example, the controller 410 may process a change in the sensor signal from the load sensor 420 and map this to a change in a load position to be effected by the load adjustment mechanism 430. In one case, the controller 410 may be configured to maintain a predefined loading on the set of front wheels, and so act to move the set of rear wheels to maintain this predefined loading. The controller 410 may send a signal to the load adjustment mechanism 430 to perform a movement similar to those shown in one of FIGS. 2B, 2C, 3B and 3C in proportion to the change in the sensor signal. For example, the controller 410 may send a signal instructing a linear actuator, such as one or more of actuators 252 and 352, to move a rear axle or a seat to a particular relative or absolute position. The controller 410 is thus adapted to better align a set of rear wheels of the wheelchair with a centre of gravity for the wheelchair by instructing the load adjustment mechanism 430.

The load sensor 420 may comprise a load cell that is located within a wheel mounting for the front wheels (e.g. within a front fork). A load cell may be provided in both front wheel mountings or only in one wheel mounting. The load cell may be located in a variety of positions. In a test configuration, the load cell was located at a top of a castor fork for the front wheels, although this may change for different implementations. The load sensor 420, in certain examples, is configured to monitor how much weight is going through the front wheels of the wheelchair and send this data to the controller 410 that controls the forward and back position of the rear axles.

FIG. 4B shows a second control system 402 that is a variation of the first control system 400. The second control system 402 is a more advanced control system with additional features. The second control system 402 comprises a controller 410, a load sensor 420 and a load adjustment mechanism 430, which are similar to those described with reference to the first control system 400. The second control system 402 further comprises an additional load sensor 425, at least one digital motor 435, one or more seat sensors 450 and an override switch 460.

The additional load sensor 425 is electrically coupled to the controller 410 in a similar manner to the load sensor 420. The additional load sensor 425 may be coupled to the same sensor interface 412 or a separate sensor interface. In one case, both load sensors 420, 425 may be communicatively coupled to a communications bus to send signals to the controller 410 In this example, each load sensor 420, 425 may be mounted within a different one of a pair of front wheel units. For example, the first control system 400 may only use a single load sensor 420 mounted in one of the pair of front wheel units, whereas the second control system 402 may use signals from load sensors 420, 425 in both front wheel units. The signals from the load sensors 420, 425 may be aggregated by the controller 410 to determine a loading of the wheelchair. For example, the signals from the load sensors 420, 425 may be averaged to determine a load position of a front-rear axis of the wheelchair. In another case, the signals from the load sensors 420, 425 may be compared to determine a load position in two dimensions, e.g. along a front-rear axis and along a left-right axis. This may be used to differentially adjust the position of the rear wheels in certain implementations and/or control differential electronic braking. In other implementations, a difference between the load sensors 420, 425 may be used to otherwise modulate the action of the load adjustment mechanism 430, e.g. to reduce a speed of movement so as to prevent instability in cases where the load is not evenly distributed across the wheelchair.

The digital motor 435 may form part of an actuator such as actuators 152, or one of linear actuators 252 or 352. A rotation of the digital motor 435 may be converted into linear motion by a linear actuator, e.g. using a rack and pinion system or a screw drive. A screw drive may be advantageous in providing smooth linear motion, and a speed of movement may be controlled by configuring the pitch of the drive and controlling a speed of motor rotation. For example, the digital motor 435 may rotate a screw drive and this may move a carriage mounted upon the screw drive. A screw drive may also provide rigidity following movement. In other cases, linear motion may be achieved without a rotating motor, e.g. using magnetic means to provide horizontal translation.

In one case, a linear movement, as described herein, may be performed in discrete steps or stages. For example, one or more ranges or thresholds may be used to measure a change in loading via one or more of the load sensors 420, 425, and actuation of the digital motor 435 may be performed based on a particular range or threshold being met. This may avoid constant movement of the rear wheels or seat in response to load changes. For example, a threshold may be set based on a default load of 2 kg on the front wheels. If the load changes, to be less than 2 kg of load, this indicates a shift of the centre of gravity backwards, and so the rear wheels or seat may be shifted backwards to maintain the predefined loading; if the load changes to be more than 2 kg on the front wheels then the rear wheels or seat may be shifted forwards. Use of a digital motor 435 may improve response times when compared to stepper motors but either may be used.

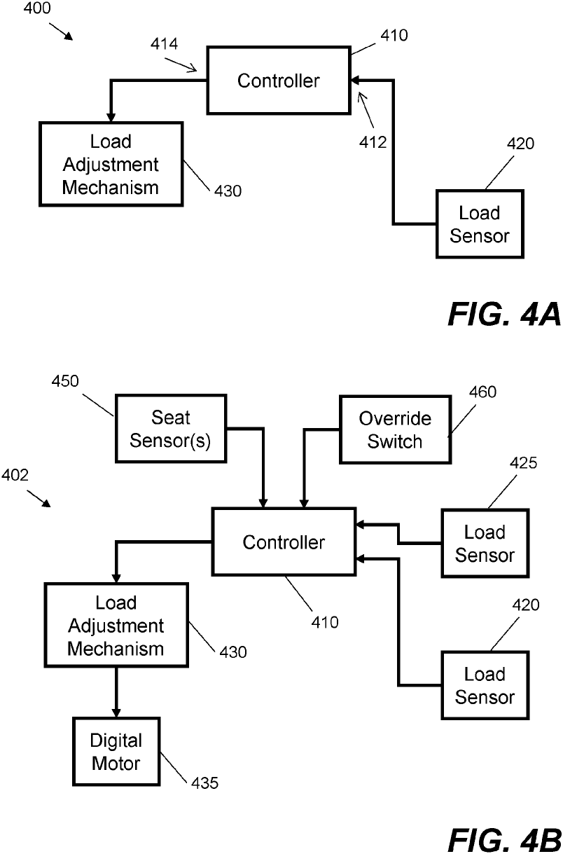

The second control system 402 of FIG. 4B also comprises a set of seat sensors 450 and an override switch 460. Each of these may be used independently. The set of seat sensors 450 may comprise one or more pressure sensors as described above. These may be used together with the load sensors 420, 425 to determine a current loading configuration for the wheelchair, e.g. to sense changes in a centre of gravity. The use of seat pressure sensors may enable a more accurate location for the centre of gravity to be determined, and/or may be used as a cross-check against the signals from the one or more load sensors 420, 425. The set of seat sensors 450 may also comprise one or more orientation sensors. These are described in more detail with reference to FIG. 5 Input from one or more orientation sensors may be used to module the adjustments performed by the load adjustment mechanism 430.

The override switch 460 comprises part of an override mechanism. The override mechanism may be implemented by at least the controller 410, and in the example of FIG. 4B is implemented by the controller 410 and the override switch 460. The override switch 460 may be located so the user can easily activate it during use of the wheelchair, e.g. it may be mounted on one of the lateral sides of the chassis or near to hand grips that form part of the platform . The override mechanism may comprise a temporary override mechanism, e.g. where the override is maintained for a pre-determined time period when activated by the override switch 460 before returning to normal operation, or may comprise a toggled mechanism that is turned off and on via the override switch 460.

In the example of FIG. 4B, a user who wishes to activate the override mechanism, flicks (or otherwise toggles or activates) the override switch 460. This sends a signal to the controller 410 to activate the override mechanism. The override mechanism comprises a mode of operation where no or limited adjustment is performed by the load adjustment mechanism 430, e.g. where no instructions are sent from the controller 410 to the load adjustment mechanism 430. This may continue for a predetermined period of time or until the user again flicks the override switch 460.

The override mechanism may be useful to help a user navigate a difficult urban environment. For example, if a user needs to mount a kerb with the wheelchair this may involve tilting the wheelchair backwards temporarily. In this case, it may be undesirable for the load adjustment mechanism 430 to attempt to stabilise the wheelchair, i.e. the user may wish to be temporarily unstable so as to mount the kerb. The user may thus flick the override switch 460 before mounting the kerb and reactivate normal operation after mounting the kerb. In certain examples, the override mechanism may alternatively, or additionally, be activated based on other sensor signals, e.g. the orientation sensors described in later examples.

In certain cases, the controllers as described herein may measure and/or otherwise determine a wheelchair centre of gravity using the signals from the one or more load sensors. A wheelchair centre of gravity may be measured as a distance from a pivot point of the rear wheels or with respect to the chassis. A range may be defined that covers possible locations of the centre of gravity with respect to the chassis. For example, this range may begin at a furthest rear position that is vertically in line with a wheelchair backrest (i.e. just behind a user’s back) and extend to a furthest front position that is vertically in line with a wheelchair footrest. The signals from the load sensors may be used to determine a position of the centre of gravity along this line, and to move the rear wheels (or the seat relative to the rear wheels) such that the centre of gravity is better aligned with the contact point between the rear wheels and the ground. In other cases, the loading on one or more of the front wheels and the rear wheels may be used as an indicator of the position of the centre of gravity, and adjustment performed in relation to detected change in the loading.

In certain examples, the controllers 410 of FIGS. 4A or 4B may be programmed to maintain a predefined loading on the front wheels. This predefined loading may relate to a minimum weight to apply through the front wheels for safe operation of the wheelchair. It may vary per user and wheelchair loading. The controller may be configured to compare a current loading, as measured with the one or more load sensors, with the predefined loading. As an example, the predefined loading may be around 1 or 2 kg. In the examples, as a user leans forward in the wheelchair and more weight is transferred to the rear wheels the controller is configured to instruct the load adjustment mechanism to move the rear wheels forward. This action keeps the majority of the user’s weight passing through the main rear wheels and avoids creating drag in the front wheels. In the case where a predefined loading is to maintained, as the user leans back, the one or more load sensors provide measurements to the controller. The controller may then determine whether the loading through the front wheels is less than the predefined loading. If the loading is less than the predefined (minimum) loading, the load adjustment mechanism may move the rear wheels backwards (e.g. by moving the rear axles backwards as shown in FIGS. 2A to 2C). This action prevents the wheelchair falling backwards as the user leans back. If the axles did not move back with the user then too much weight would be distributed to the back of the wheelchair causing it to tip.

FIG. 5 shows an example wheelchair 500 with an orientation sensor 572. The orientation sensor 572 may be one of the seat sensors 450 shown in the second control system 402 of FIG. 4B or may be used in a separate implementation. In any case, the orientation sensor 572 may be electrically coupled to a controller that controls the operation of the load adjustment mechanism as described in examples herein. Although FIG. 5 shows one orientation sensor 572, multiple orientation sensors may be provided in other examples, where an input from the multiple orientation sensors is aggregated (e.g. averaged) to provide a common orientation signal. The orientation sensor 572 is configured to sense an orientation of the wheelchair and to send a signal indicating this to the controller.

In the example of FIG. 5, the orientation sensor 572 comprises a tilt sensor that is mounted on, or as part of, a platform 560. The platform 560 may comprise a platform for a seat such as platform 160 in FIGS. 1B to 1D. In other examples, the orientation sensor 572 may comprise a gyroscope or the like. The orientation sensor 572 may sense an orientation in one or more directions. The orientation sensor 572 of FIG. 5 is configured to sense an orientation of the platform 570 with respect to the horizontal. In other examples, the orientation sensor 572 may be located in a different location (e.g. within or upon the lateral sides of the chassis or as part of the footrest or rear back support) and/or sense a different angle. The orientation sensor 572 is primarily configured to sense a relative orientation, e.g. an orientation with respect to a normal (e.g. horizontal) orientation of the wheelchair. As such, any initial angle may be calibrated as a reference angle (including an orientation other than horizontal if the orientation sensor is mounted in other locations).

FIG. 5 shows how the orientation sensor 572, in the form of a tilt sensor, may comprise a moveable member 574 such as a ball bearing or a liquid conductive material, such that a signal emitted by the orientation sensor 572 changes as the orientation of the sensor changes. For example, FIG. 5 shows the orientation sensor 572 being tilted backwards at 582 and tilted forwards at 584. This may correspond to the platform 560 and the wheelchair 500 being tilted backwards and forwards. In each of the different states 582 and 584, the moveable member 574 moves within the orientation sensor 572 and thus a different electrical signal is provided to the controller.

The signal from the orientation sensor 572 may be used by the controller to modulate operation of a load adjustment mechanism as described herein. In one example, the orientation sensor 572 may be used to activate the aforementioned override mechanism. In another case, the orientation sensor 572 may be used to configure load adjustment when navigating slopes, inclines or hills. In this case, the controller may be configured to increase a loading on the front wheels when going up a hill or incline and to decrease a loading on the front wheels when going down a hill or incline.

The orientation sensors as described herein may be used to “read” the road ahead for wheelchair users. For example, when a wheelchair user has to get the wheelchair up a kerb or other obstacle they must tip the chair back and lift the front wheels lift off the ground. The orientation sensors provide a means for a controller to detect this motion a deliberate action, rather than determining that the signals from the load sensors indicate a possible backwards fall that requires load adjustment. The orientation sensors thus allow the ground in front of the chair to be “read” allowing the load adjustment system to switch on and off automatically when it “sees” an obstacle. Additionally, or alternatively, the override mechanism described herein may also be used to manually switch on and off the same mechanism.

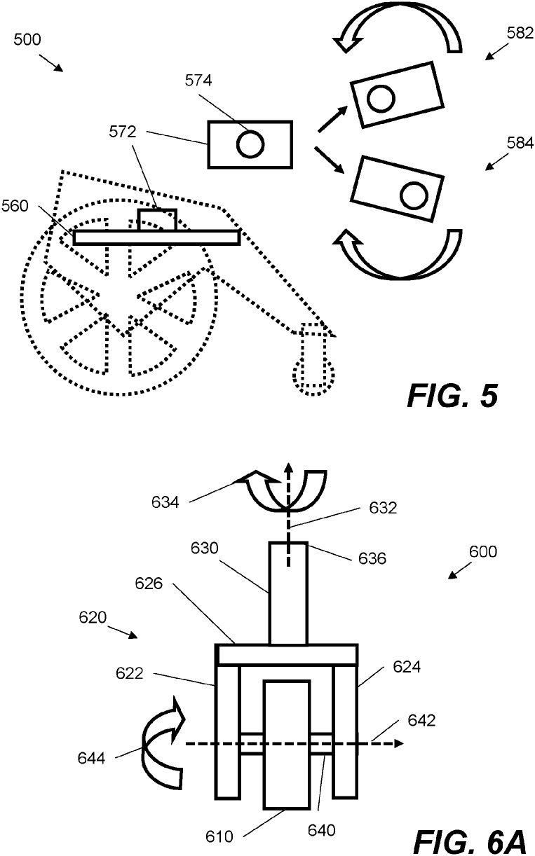

FIGS. 6A and 6B show an example of a front wheel unit 600 for a wheelchair. The front wheel unit 600 may form part of the wheelchair or may be removable mounted. A pair of front wheel units 600 may implement the set of front wheels 130 shown in FIGS. 1A to 1D.

The front wheel unit 600 comprises a front wheel 610 and a wheel mounting 620. In FIG. 6A the wheel mounting 620 forms an enclosure for the front wheel 610 and comprises side members 622 and 624 and upper member 626. The wheel mounting 620 may comprise a fork. It may be constructed from separate members or preferably formed as a single piece. The front wheel 610 lies at least partially within the wheel mounting 620. The upper member 626 is coupled to a head tube 630. The head tube 630 may comprise a cylindrical member that is rotatable about a steering axis 632 (the arrow 634 shows this rotation). Rotation of the front wheel 610 about the steering axis 632 allows an angle of attack for the front wheel to be variable with respect to the wheelchair.

In one case, the head tube 630 may comprise nested cylindrical members that are allowed to rotate around each other (e.g. by way of bearings or the like). In this case, one cylindrical member of the head tube 630, e.g. an outer member, may be statically fixed to a chassis of the wheelchair, such as at coupling 136 in FIG. 1D, and another cylindrical member, e.g. an inner member, may be statically fixed to the upper member 626 and free to rotate within the outer member, thus allowing the front wheel to rotate about axis 634 when the front wheel unit 600 is coupled to the wheelchair. In another case, the head tube 630 may be replaced with a cylindrical coupling member that is fixably mounted to the top of the wheel mounting 620 and is able to rotate within a mounting on the wheelchair chassis.

The front wheel unit 600 comprises a mechanical interface 636 for mechanically coupling the front wheel unit 600 to the wheelchair. The front wheel unit 600 may be attached to the chassis of the wheelchair using a castor fork (e.g. where head tube 630 forms part of this castor fork), where the castor fork is connected to a spindle that fits into a housing of the chassis where bearings are located. For example, in a case where the head tube 630 comprises an outer member to be statically fixed to the wheelchair chassis, the outer member may be clicked into place using a mechanical fastening. The mechanical interface 636 may comprise a quick-release mechanism whereby pressure applied to a button pushes against a spring member and allows a decoupling of the front wheel unit 600 from the chassis. In another case, the mechanical interface 636 may comprise a clamp that is fastened onto the chassis. Different mechanical couplings may be used depending on the implementation.

FIG. 6A shows how the front wheel 610 is coupled to an axle 640 that is mounted within side members 622 and 624. This mounting enables the front wheel 610 to rotate about the axis 642 as shown by the arrow 644. This may be achieved in a number of different ways: e.g. the front wheel 610 and axle 640 may be fixably coupled but rotatable within the side members 622 and 624; or the front wheel 610 may rotate about the axle 640, which may be fixably mounted within the side members 622 and 624. The axis 642 may be perpendicular to the steering axis 632.

FIG. 6B shows a set of inner electrical components that may be provided as part of the front wheel unit 600. In FIG. 6B, a load sensor 650 is shown that is mounted with the head tube 630. In other examples, the load sensor 650 may be placed anywhere within the front wheel 610, the wheel mounting 620 or the head tube 630 that allows a load applied to the top of the front wheel unit 600 to be measured (e.g. that is distributed to the ground via the front wheel 610).

In FIG. 6B, the load sensor 650 is configured to sense a load applied to the front wheel and is electrically coupled to an electrical interface 660. The electrical interface 660 provides an electrical coupling between the front wheel unit 600 and the wheelchair. The electrical interface 660 may provide power to the front wheel unit 600 from the wheelchair and receive sensor signals from sensors mounted within the front wheel unit 600. Although not shown, the front wheel unit 600 may further comprise processing circuitry that is electrically coupled to the load sensor 650 to provide one or more signal pre-processing operations (such as amplification, smoothing, analogue-to-digital conversion and/or noise removal) prior to a signal being communicated across the electrical interface 660 to a control system of the wheelchair, e.g. the controller of one of the control systems 400 or 402 shown in FIGS. 4A and 4B.

FIG. 6B also shows a motor 670 located within the front wheel 610 that may be used to rotate the front wheel 610 about the axis 642 of the front wheel to at least assist in propelling the wheelchair, e.g. to assist with the manual propulsion of the wheelchair when a user is present. The motor 670 is mounted within the front wheel 610 in the present example as this provides a simpler form factor; the motor 670 is not visible nor does it substantially modify the size or shape of the front wheel unit 670. However, in other examples the motor 670 may be mounted externally, e.g. within or upon the wheel mounting 620.

The motor 670 may be powered by a battery (such as a lithium ion battery). The battery may be mounted within the front wheel 610 with the motor 670, within the wheel mounting 620 or the head tube 630, or upon or within the chassis of the wheelchair. In the latter case, power from the battery may be supplied using the electrical interface 660. In the example of FIG. 6B, the motor 670 is also electrically coupled to the electrical interface 660 to allow control from the wheelchair (e.g. by the controller of previous examples). Although FIG. 6B shows the motor 670 and the load sensor 650 as being electrically coupled to a common interface (e.g. as provided by a systems or communications bus), in other examples, they may have respective separate electrical interfaces and signal pathways.

The front wheel unit 600 may be used with the wheelchair of any of the previous examples to provide a power-assist system. Preferably two front wheel units as shown in FIGS. 6A and 6B are provided to provide a pair of front wheels for the wheelchair. In certain cases, a front wheel unit similar to that shown in FIG. 6A but without the motor 670 of FIG. 6B may be provided as a base configuration for the wheelchair. In this case, power-assist functionality may be provided by exchanging an unpowered front wheel unit for a powered front wheel unit similar to that shown in FIG. 6B. This may, for example, by provided as an optional upgrade depending on user requirements.

When the motor 670 shown in FIG. 6B (or another front wheel motor) is powered then a torque applied to one or more of the set of front wheels by the at least one motor assists the manual propulsion of the wheelchair using the set of rear wheels. In one case, a torque experienced by the motor 670 may be sensed, e.g. without power to the motor, and then power may be supplied to the motor 670 to provide the same level of torque. This may reduce the strain on the user. In certain cases, a switch similar to that of the override mechanism of the previous examples may be provided to switch a power-assist functionality on and off, e.g. where when on a powered torque is provided by the motor 670. A powered torque may be further advantageous with difficult ground surfaces or when going uphill (e.g. to provide additional grip). A speed of rotation of the motor 670 (e.g. an applied powered torque) may be controlled by a user (e.g. using a knob, dial, pressure button, joystick or the like) and/or may be automatically provided based on a desired level of assistance (e.g. to match at least a portion of a sensed torque as described previously). Providing a motor in the front wheels, and leaving the rear wheels to be manually propelled, may help to reduce cost, and means that a lower powered (and smaller) motor may be used.

In one case, a power-assist functionally may have a number of levels of intervention. Each level may be associated with a predefined and increasing torque that is applied by one or more motors such as motor 670. In this case, the user may select a desired mode (e.g. by pressing a button a number of times or using a knob or dial) to apply a given predefined level of torque. In one case, a level of intervention may be increased until the wheelchair is on a point of moving forward. The user may then still control forward motion by manually pushing the rear wheels, but the effort required is less than a non-assisted case (or the user is able to be propelled further forward for the same effort). In use, where the front wheel motor and controller define a number of pre-defined torque level (e.g. range) settings that may be manually selected via the controller, a user may find that they are pushing the chair at a speed beyond that enabled by the torque setting selected (e.g. the lowest torque setting) and they may select the next torque level.

In certain cases, the motor 670 (and wider power-assist system provided by the front wheel units 600) may also be used to provide a powered braking function. In this case, if a sensed torque exceeds an instructed torque (or an average or default torque) then a force may be applied to reduce the torque applied by the motor 670 and reduce a speed of rotation of the front wheel. For example, this may be desirable when travelling down an incline such as a hill. The power-assist functionality may thus help with navigating slopes and other difficult landscapes. As with the power assist motive function described above, power assist braking may be automatically initiated in dependence upon detected factors, such as speed and/or acceleration and degree of incline. Or, power assist braking may be initiated by the user selecting a level (corresponding to a torque level in a range or a pre-defined torque range according to a pre-defined setting) via a controller and may optionally adjust or change the level as required.

If two front wheel units are provided with motors, then the controller of the previous examples, or another set of control circuitry, may be used to provide a directional control system to steer the wheelchair. In this case, different torques may be applied to each motor (e.g. by varying a supplied power to each motor). The torque differential may then have the effect of steering the front of the wheelchair. This may allow steering without a second motor applying a rotation about steering axis 632.

In one case, a drive system arranged to power each front wheel may be used to provide a remote control functionality for a user. For example, a user may connect to a controller of the wheelchair via a wired or preferably wireless connection, and use the controller to supply power to the motors 670 to move the wheelchair. For example, a user may use a smartphone or other portable computing device to wireless connect to the wheelchair so as to steer the wheelchair to them. This may be useful when the user is at a distance from the wheelchair, e.g. is sitting in an office or in bed with the wheelchair stored safely out of the way. In this case, a user may use their smartphone to remote control the wheelchair and steer it to their location where they can get into the wheelchair. In one case, the motors 670 do not need to be able to move the wheelchair as loaded with a user, but only need to be able to move an unloaded wheelchair. This means that smaller, lower power motors may be used, which may reduce cost and also allow a mounting such as that shown in FIGS. 6A and 6B. Using powered motors to assist manual propulsion further allows for longer battery life (e.g. all day power), whereas larger and heavier batteries may be required for powered wheelchairs that do not allow manual propulsion. In other cases, more powerful motors may be used that allow a user to be propelled using the front wheels when present in the wheelchair (although this may be time limited - a so-called “boost mode” - depending on battery power).

The front wheel units 600 shown in FIGS. 6A and 6B, and the broader concept of power-assisted front wheels as described herein may be used together with the centre of gravity adjustments (e.g. as described with reference to FIGS. 2A to 3C) or separately from these aspects. When used separately, a manually propelled wheelchair may comprise a chassis to accommodate a seat, a pair of rear wheels for manual propulsion arranged either side of the chassis, a pair of front wheels, and a drive system for the pair of front wheels, wherein the drive system comprises at least one motor coupled to the pair of front wheels. In this case, as described above, a torque applied to one or more of the set of front wheels by the at least one motor at least assists the propulsion of the wheelchair. This wheelchair may further allow the remote control operation by way of a directional control system to adjust a direction of the wheelchair by instructing a differential torque to be applied to one or more of the set of front wheels. In this case, the drive system and the directional control system enable remote control of the wheelchair when a load is absent from the seat. When used separately the drive system may further provide the powered braking function as discussed above, e.g. a torque may be reduced or provided in an opposing direction when a sensed torque on one or more of the set of front wheels exceeds a pre-defined threshold.

In examples where the aforementioned power-assist functionality is used together with the load or centre of gravity adjustment described above, there may be synergies. For example, in a remote control mode as described above, e.g. when a user (i.e. a load) is absent from the seat, the load adjustment mechanism may be configured to increase a load upon the set of front wheels (e.g. by shifting the rear wheels backwards or the platform/seat forwards). This may increase the frictional force between the front wheels and the ground to improve the remote movement, e.g. to enable the directional control system and the power-assist system to propel the wheelchair. When the user moves into the wheelchair, the load adjustment mechanism may return the rear wheels or seat to a default position.

In a similar manner, the load adjustment mechanism may additionally, or alternatively, be configured to adjust a load upon the set of front wheels dependent on the torque applied by the power assist system. For example, if the user wishes to use a power assist mode, and use the motors 670 to help propel the wheelchair, it may be beneficial to increase a load on the front wheels (e.g. to again increase frictional forces). In this case, the controller may be configured to control the load adjustment mechanism in proportion to the power supplied to the front wheels (e.g. to sift the wheels backwards or the seat forwards when using the power-assist functionality and/or to shift in an opposite direction when not using the power-assist functionality).

As another example, when the power-assist functionality is applied, this may be activated when going uphill to ease a burden on the user. In this case, it may be desired to adjust the loading of the wheelchair to increase a loading on the front wheels, e.g. to increase grip. In this case, a signal from an orientation sensor, e.g. as described with respect to FIG. 5, may be used to override a default load adjustment to move the rear wheels backward and increase the front wheel loading.

Applying a torque to the front wheels and/or increasing a load on the front wheels via a load adjustment mechanism may also be used to steady the wheelchair while a user is getting in and out. For example, increasing a load and/or applying a braking torque (e.g. a torque in a direction opposite to a sensed torque) may help stop the wheelchair moving (e.g. sliding backwards or rolling away) when a user is trying to move from a chair or a bed into the wheelchair.

In certain examples described herein, the advanced wheelchair may be provided with an electronic braking system. As described above, electronic braking may be provided using the power-assist functionality of the front wheels. In certain cases, a set of front wheels may be provided that do not have a motor but that do have another form of electronic braking system. This electronic braking system may be coupled to the aforementioned controllers of FIGS. 4A and 4B. An electronic braking system may use electronically actuated hub brakes, disk brakes or rim brakes, or a version of the torque applied braking described above. An electronic braking system on the front wheels may be controlled automatically via the controller based on sensor readings or manually by the user using a control unit (e.g. a brake lever or button coupled to controller). In one case, automatic control of an electronic braking system may use the orientation sensors described herein and shown, for example, in FIG. 5. With one or more orientation sensors, the degree of slope the wheelchair is on may be sensed (e.g. during downhill motion) and an amount of braking may be determined that controls the speed of descent.

If electronic braking is provided on both front wheels then this allows the independent braking of left and right front wheels. By independently controlling a braking force applied to each wheel, the user may be better able to navigate cambered surfaces where the wheelchair wants to pull to one side (e.g. towards the lower aspect of the pavement such as the kerb edge). In these cases, an orientation sensor or gyroscope that measures a lateral tilt may be used to differentially control the braking, or the user may manually choose to apply braking to just one wheel. Both approaches may reduce the tendency for the wheelchair to pull to the side. This may also allow the user to push the chair with both arms evenly and not have to push with just one arm to keep moving in a straight line.

An electronic braking system may also be used in conjunction with the load adjustment mechanism. In this case, when braking needs to be applied the controller may be configured to move the rear axles rearward (or to a furthest rear position) to increase a loading on the front wheels and improve braking. This action may also be applied when a user is transferring to the wheelchair to increase stability.

In certain examples, a position of the rear wheels and/or seat may be adjusted by a user as well as, or instead of, by the load adjustment mechanism described herein. For example, there may be a plurality of set positions for one or more of the rear wheels and the seat and these may be selected via a user interface (such as a set of buttons or dial or the like). For example, there may be three positions such as: 1) Stable; 2) Leisure; and 3) Sport. Position 1) may be associated with a relatively high predefined loading on the front wheels (and so be associated with a rearward position of the rear wheels - such as in FIG. 2C), position 2) may be associated with a central position of the rear wheels (e.g. the default in FIGS. 2A or 3A), and position 30 may be associated with a relatively low predefined loading on the front wheels (and so a frontward position of the rear wheels such as in FIG. 2B). These positions or modes may be used even if the dynamic load adjustment is not activated or present. If the dynamic load adjustment is activated, each position or mode may have an associated predefined loading on the front wheels so as to change a default position of the seat and/or rear wheels.

A similar set up may be provided for one or more of electronic braking and power assist functionality. In these cases, the user may select a pre-determined level of braking for descending a slope or a pre-determined level of powered assistance. This may enable the user to keep their hands free to steer the wheelchair.

In certain examples, the powered front wheels may comprise a memory capability allowing a route to be stored and retrieved. A route may be stored as a series of applied torques, braking and/or steering instructions. In one case, a controller of the wheelchair may monitor a pattern of torques applied by the front wheels and then be able to “playback” this pattern to repeat a movement. This function may be used for user to travel hands free for frequent short journeys, such as from a kitchen to the lounge to allow a user to carry a cup of tea with their hands, or from a work top to a fridge to transport groceries.

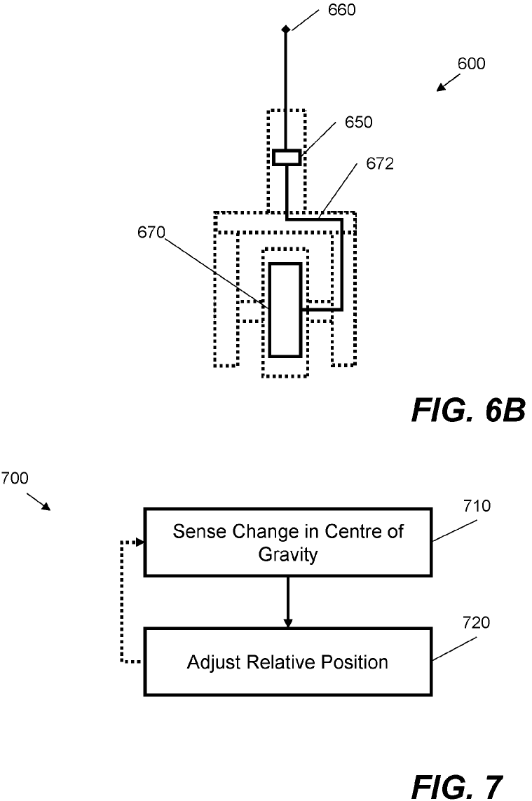

FIG. 7 shows a method 700 of operating a manually propelled wheelchair according to an example. The method may be used in association with any of the previously described example wheelchairs or with a different wheelchair design.

At block 710, the method comprises sensing a change in a centre of gravity for the wheelchair at least along an axis between a set of front wheels and a set of rear wheels. For example, this may be performed using one or more signals from a set of load sensors and/or a set of pressure sensors. The axis may reflect a front-back axis of the wheelchair and represent a loading dimension. Sensing a change in a centre of gravity may comprise detecting an increased or decreased loading on a particular portion of the wheelchair, e.g. a front and/or rear portion of the wheelchair. The centre of gravity may change when a user shifts their weight within the wheelchair (e.g. leans forwards or backwards) or when additional external loads are applied (e.g. bags or when the wheelchair is pushed from behind).

At block 720, the method further comprises adjusting a relative position of the set of rear wheels compared to a seat of the wheelchair based on the change. This may comprise moving one or both of the rear wheels or moving the seat, where the seat is configured to receive a load (i.e. a user) for the wheelchair. While the centre of gravity may remain in the sensed new position, movement of the rear wheels relative to the seat changes that forces that are distributed through the contact points of the wheelchair with the ground, i.e. the front and rear wheels. For example, the wheelchair may be seen to pivot about the rear wheels. It may thus be desired to maintain a relatively constant moment about the rear wheels. When a user or the loading changes, the distance between the centre of gravity and the pivot point of the rear wheels may change. If this happens, this may be sensed at block 710 and then at block 720, either the pivot point or the centre of gravity may be shifted (e.g. by shifting the rear wheels or the user via seat movement) to restore the previous desired moment.

Any of the variations of the previous examples may be applied to this method. For example, block 710 may comprise sensing a load applied through one or more of the set of front wheels, and block 720 may comprise moving one of the set of rear wheels and the seat of the wheelchair based on the load. The load may, for example, be sensed via one or more sensors located in the front forks or mountings for the front wheels. Block 720 may also comprise moving one or more axles coupled to the set of rear wheels relative to a chassis of the wheelchair.

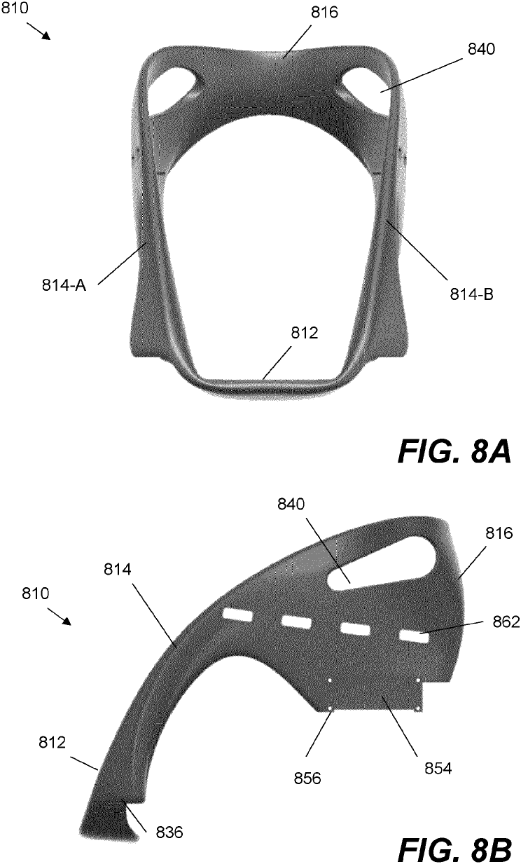

FIGS. 8A and 8B show an example design for a single piece chassis 810 that may be used together with the other examples described herein or separately to provide an advanced wheelchair. FIG. 8A shows a perspective view and FIG. 8B shows a side view. This chassis design is provided for example only and may vary in practice depending on the implementation. However, certain aspects of the design that provide functional benefits that may be conversed in whole or in part across different designs are described below. It may be seen how the chassis 810 corresponds to the schematic illustrations of FIGS. 1A to 1D, e.g. to chassis 110.

The single-piece wheelchair chassis 810 may be made from a lightweight material. This may include carbon based materials, such as carbon fibre and graphene as well as composites and polymer materials (i.e. plastics and the like). The chassis 810 comprises a front frame portion 812, two respective side frame portions 814-A and 814-B and a rear frame portion 816. These frame portions are continuously coupled as part of the single piece. The size, shape and thickness of the portions is configured to efficiently distribute the loads of the wheelchair. Using a single piece reduces stresses within the structure, e.g. as compared to bonded multi-piece structures. The front frame portion 812 may be used as a footrest and for coupling a set of front wheels. For example, the front wheels may be clamped directly to the front frame portion 812 (e.g. to the area indicated as 836 in FIG. 8B) or coupled by an intermediate coupling plate that is attached to section 836. In one case, portion 836 may comprise apertures for receiving the head tube 630 as shown in FIG. 6. In certain cases, the front wheels may be bolted onto the chassis using a thread stem. A castor fork for the front wheels may be coupled to the thread stem and held by a nut. Areas 850 of the side frame portions are configured for the coupling of a set of rear wheels. Apertures 840 are also provided towards the rear of the side frame portions 814. These may be used to help push or carry the wheelchair, and may be used by a user to get in and out of the seat of the wheelchair. The rear frame portion 816 may be used as a lower back support. In certain cases, an additional rear support may be coupled to the rear frame portion 816 (or other inserted).

As shown in FIG. 8B, the design of the present example is further adapted to attach a platform or seat and a load adjustment mechanism. Apertures 862, which in FIG. 8B comprise four evenly-spaced substantially rectangular apertures, may be used to couple a platform such as 160 in FIG. 1B to the chassis 810, and/or provide slots within which a seat may be clipped into place. Alternative mechanisms to attach a platform or seat may be provided in other examples. In the present case, a seat may be provided that comprises a series of straps that loop around anchor points on the chassis 810. In this case, the straps may be fastened around the apertures 862, e.g. using (fabric) hook and loop fasteners. In this case, four straps may be used but this configuration may vary according to implementation. A cushion may then be placed or fastened to the straps. The seat may be constructed using a fabric upholstery or a carbon felt sheet, amongst others.

The side frame portions 814 of the chassis 810 comprises areas 854 for the coupling of a load adjustment mechanism such as 150 in FIG. 1B. This area 854 further comprises circular apertures 856 located within the corners of the area to attach the load adjustment mechanism. For example, the load adjustment mechanism may comprise a linear actuator that is bolted to area 854 using the circular apertures 856.

A single piece lightweight chassis, such as that shown in FIGS. 8A and 8B may be used in combination with, or separately to, the previously described examples. When used in combination there again may be synergies. For example, the lightweight frame may allow for better load adjustment as more of the weight of a loaded wheelchair is provided by a user. A lightweight single-piece frame may be easier to manoeuvre when unloaded in a remote control mode. The frame shown in FIGS. 8A and 8B may also allow for efficient distribution of loads through the side portions to the front portion of the frame to effect the power-assist and load adjustment modes.

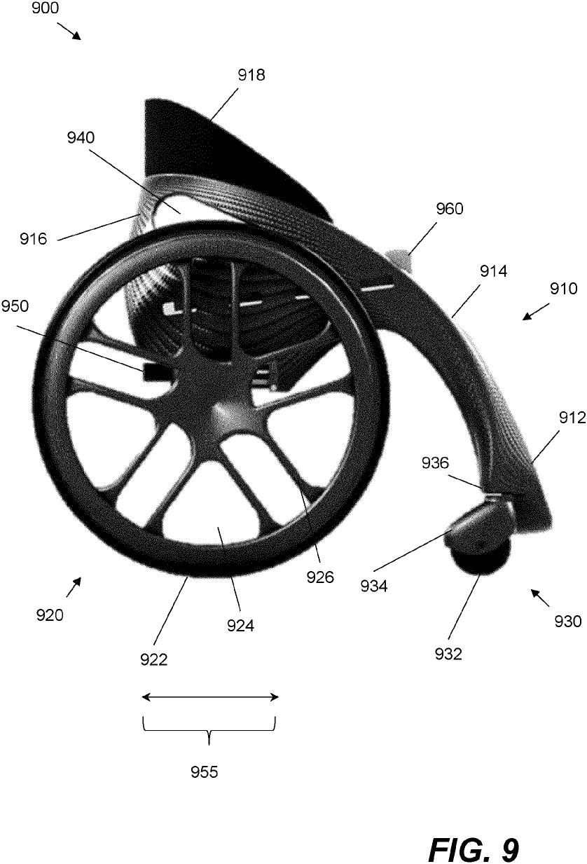

FIG. 9 shows an example of a prototype advanced wheelchair 900 that combines the previously described aspects. FIG. 9 may be one implementation of the features shown schematically in the other Figures. The wheelchair 900 comprise a single piece chassis 910 having a front frame portion 912, side frame portions 914 and a rear frame portion 916, similar to the chassis 810 showed in FIGS. 8A and 8B. Apertures 940 are also provided as well as a removable rear support 918 that is couplable to the rear frame portion 916. The wheelchair 900 has a pair of rear wheels 920 and a pair of front wheels 930. The rear wheels 920 comprise an outer rim 922 that may be used to manually propel the wheelchair with the hands when seated within the rear of the chassis 910. The rear wheels comprise open portions 924 between spokes 926. The rear wheels are coupled to a load adjustment mechanism 950. The load adjustment mechanism may comprise one or more linear actuators to move the rear wheels forward and backwards within the range 955. The edge of a seat 960 is shown, where the seat may comprise a cushion that is mounted upon a platform that extends as indicated by the dashed portions behind the rear wheel 920. In this example, the platform is fixably mounted (e.g. the seat does not move as shown in the example of FIGS. 3A to 3C). The rear wheels 920 may comprise a quick release axle so they can be removed from the wheelchair 900 via a push button release.

In this example each of the pair of front wheels 930 is provided by a front wheel unit that is coupled to a front of the front frame portion 912 at coupling 936. Note that the coupling 936 need not be horizontal as shown in the Figure and in other cases may be vertical. In FIG. 9, the front wheel 932 and the wheel mounting 934 may rotate around a vertical steering axis aligned with the coupling 936. In one implementation, the front wheel 932 may comprise an inner motor, similar to motor 670, to provide a power assist functionality. The load sensors as previous described may be located as part of the coupling 936, within the wheel mounting 934 and/or within or upon the side frame members.

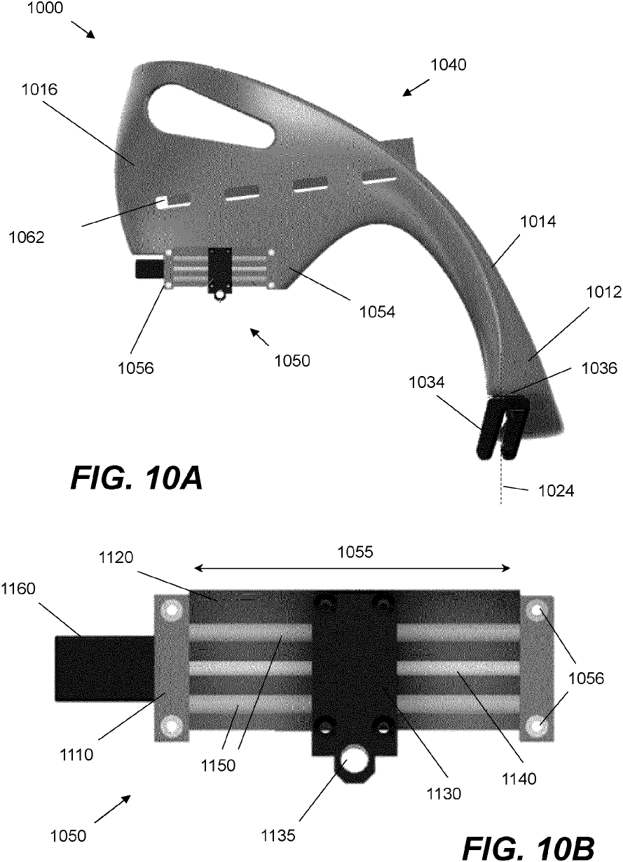

FIG. 10A shows a side view of a wheelchair 1000 that is similar to wheelchair 900 but with certain components removed for better visibility of other components. The wheelchair 1000 may be constructed using the chassis 810 shown in FIGS. 8A and 8B. The wheelchair 1000 has a chassis with a front frame portion 1012, side frame portions 1014 and rear frame portion 1016. The side frame portions 1014 comprise areas 1054 for mounting the rear wheels via a load adjustment mechanism 1050. An example load adjustment mechanism 1050 comprising a linear actuator is shown in more detail in FIG. 10B. The shown linear actuator uses a screw drive. The wheelchair 1000 is shown with a seat 1040 mounted via spaced apertures 1062, which may be seen to correspond to the apertures 862 shown in FIG. 8B. A coupling 1036 for a front wheel mounting 1034 is also shown, minus the front wheel within the mounting. The wheel mounting 1034 is rotatable about a steering axis 1024 that is colinear with the coupling 1036 . This method of coupling a front wheel unit may also be used to provide the coupling 936 in FIG. 9.

FIG. 10B shows the load adjustment mechanism 1050 of FIG. 10A in more detail. Each rear wheel may have a corresponding mechanism as shown, or in other examples a single mechanism may move a set of coupled rear wheels. The load adjustment mechanism 1050 comprises a housing 1110 that is fastened to area 1054 of the chassis in this example via screws 1056, which are aligned with corresponding circular apertures in the chassis (e.g. similar to apertures 856 in FIG. 8B). In certain examples, the load adjustment mechanism 1050 may be mounted with a recess 1120 in area 1054 of the chassis. In other examples, the load adjustment mechanism 1050 may be fastened without being recessed. Other fastening mechanisms may also be used in other examples.

The housing 1110 contains a carriage 1130 that travels along screw member 1140 in the directions indicated by range 1055. The carriage 1130 is further guided by elongate upper and lower guide members 1150, which provide support for the carriage 1130 as it moves forward and back. The carriage 1130 comprises an axle aperture 1135 that is useable to mount an axle of a rear wheel (such as axle 228 of FIGS. 2A to 2C). It may be seen how the load adjustment mechanism 1050 is an implementation of the schematic example shown in FIGS. 2A to 2C. The carriage 1130 may comprise a digital motor 1160 that rotates the screw member 1140 to move the carriage 1130 along upper and lower guide members 1150, where rotation in a first direction moves the carriage 1130 forward (i.e. to the right in FIG. 10B) and rotation in a second, opposite direction moves the carriage 1130 backward (i.e. to the left in FIG. 10B). Although the digital motor 1160 is shown in horizontal alignment with the screw member 1140, it may be located at another orientation (e.g. vertical), with suitable gearing to translate the rotation. Suitable linear actuators using a screw drive are known in the art. The present example uses a digital motor on both sides of the wheelchair. In other examples, only one digital motor 1160 may be provided for both sides of the wheelchair, wherein a linking or frame member that couples the rear wheels may be used to move both wheels in tandem. In this latter case, a non-driven side may omit the screw member 1140 and the digital motor 1160.

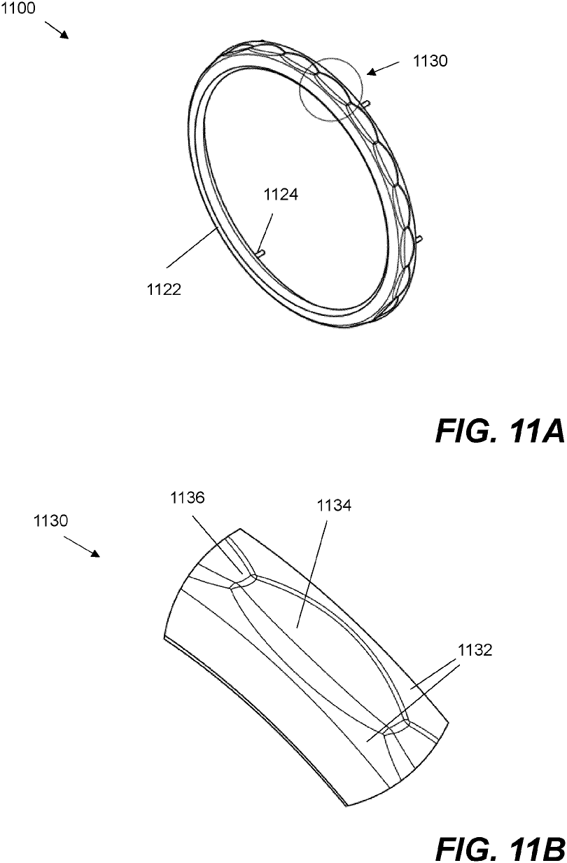

In the example of FIG. 9, the outer rim 922 is used by the user to propel the wheelchair 900, e.g. via their hands. The outer rim 922 may comprise a push rim, a form of tube or circular member that extends around the circumference of the rear wheels 920 to help a user push the rear wheels. In one variation, the outer rim may be configured to comprise flat portions for the palm of the hand while being otherwise round. This is shown in FIGS. 11A and 11B.

FIG. 11A shows an example 1100 of a wheel rim 1122 that may be used to implement the outer rim 922 of FIG. 9. The wheel rim 1122 may be mechanically coupled to a rear wheel via a set of studs 1124 or other fastening mechanism. As such the wheel rim 1122 may comprise a separate “bolt on” item for a wheelchair. In other examples, the wheel rim 1122 may alternatively be moulded with the rear wheel as one component. FIG. 11A shows how a set of flat portions 1130 may be arranged around the wheel rim 1122. Further detail of the flat portions 1130 are shown in the close-up view of FIG. 11B.

The flat portions 1130 provide a flat surface into which the palm of the hand can land and push from. This may be contrasted with comparative purely circular or round designs (e.g. tube-like rims similar to a wheel) that may not fit the hand as well and be more difficult to hold, and with comparative purely angular rims, e.g. with a polygonal form, which may not run through the hand at speed (e.g. would feel “bumpy”) and may create vibrations up the arm.

For example, the outer surface 1132 of the wheel rim 1122 (i.e. that faces upwards towards the user) comprises a round tube-like member with concave, elongate, yet shallow pitted portions 1134 along the outer surface (e.g. in series around the surface that makes contact with the user’s hand). This design may thus feature areas for the user’s palm (the concave pits) yet still retain a relatively smooth angled roughly circular form so the hand can run through the smoothly when freewheeling. The edges of the concave pitted portions 1136 may be smoothed so that the wheel rim 1122 retains a substantially smooth and circular outer form while also allowing the concave pitted portions 1136 to provide a flatter surface for the palm.

Certain examples described herein provide an advanced or “smart” wheelchair with many improvements for a user.

In one example, sensors within a front frame or front set of wheels may be used to sense a load (e.g. an applied weight that is distributed through the front wheels). If the user is leaning forward, e.g. as they would when pushing fast, the sensors detect extra weight in the front wheels and move the rear or main wheel axles forward thus transferring weight to the rear wheels and reducing a load on the front wheels. If the user leans back, e.g. when decelerating, the sensors detect that weight has been shifted away and the axles are moved rearward creating rearward stability. This may occur in stages and/or as a dynamic adjustment that is performed constantly over time. The speed of adjustment may be configured (and in certain cases modulated). The adjustment may thus be configured to range from a very reactive, fast mechanism that is constantly adjusting itself to a slower, more damped adjustment that may occur periodically or in stages. In certain cases, e.g. for high manoeuvrability, the wheelchair may be effectively balanced on the rear wheels with very little weight in the front wheels at all. Movement of the rear wheels in relation to the seat acts to adjust a pivot point for the wheelchair relative to a user’s weight distribution within a range set by an onboard control system. The load adjustment mechanism described here may provide a dynamic centre of gravity system that utilising a weight-shifting arrangement, which serves to optimise the centre of gravity for efficiency of user mobility while avoiding tipping risk/maintaining stability. The dynamic centre of gravity system also serves to moderate traction of the front wheels. A power-assist functionality may further be provided, in combination or separately, to improve control and manual propulsion, and to allow the wheelchair to be moved when unloaded, in relation to an immobile user. When used in combination, the load adjustment function can ensure sufficient downward force is applied on the front wheels or a front wheel drive system to provide improved straight-line traverse along a slope.

Certain examples described herein provide an intelligent centre of gravity adjustment that aims to keep the user weight travelling through the rear axles as much as possible and avoid excess weight being carried by the front wheels. Reducing the weight through the front wheels means that less drag will be generated, and the wheelchair will be easier to push and turn and also safer from tipping backwards. This reflects the fact that the most common accident faced by wheelchair users is falling backwards due to over balancing.

The present examples further provide an improvement over wheelchairs where the rear wheel axles are simply mechanically adjusted to be located at a far rear adjustment position (e.g. via a one-off manual adjustment when the user is not seated). This may reduce the risk of the wheelchair toppling backwards but results in a large amount of drag on the front wheels, which makes the wheelchair difficult to manoeuvre. If the rear axles were alternatively permanently located at a forward position, this would reduce the drag, making the wheelchair easy to push but would result in a wheelchair that is unstable and prone to tipping backwards. As a result, many wheelchair users select a fixed axle position that is neither to the back or the front resulting in a wheelchair that is neither very agile nor very stable. The present examples provide a dynamic adjustment mechanism that provides the benefits of low drag and stable positioning by moving the rear wheels relative to the seat dependent on conditions in use.

The invention has been described with reference to a preferred embodiment. However, it will be appreciated that variations and modifications can be effected by a person of ordinary skill in the art without departing from the scope of the invention.

1. A manually propelled wheelchair comprising:
a chassis to accommodate a seat;
a set of rear wheels for manual propulsion arranged either side of the chassis;
a set of front wheels;
one or more sensors to detect a loading of the wheelchair; and
a load adjustment mechanism to adjust a position of the set of rear wheels relative to the seat in response to signals from the one or more sensors.

2. The wheelchair of claim 1, wherein the set of rear wheels are moveable and wherein the load adjustment mechanism is configured to adjust a position of the set of rear wheels.

3. The wheelchair of claim 1,wherein the load adjustment mechanism is configured to adjust a position of the seat within the chassis.

4. The wheelchair of claim 1, wherein the one or more sensors comprise one or more sensors to detect a load applied to one or more of the set of front wheels.

5. The wheelchair of claim 4, wherein the load adjustment mechanism comprises:
a controller to receive the signals from the one or more sensors and instruct an adjustment to the position of the set of rear wheels relative to the seat,
wherein the controller is configured to detect a reduction in the load applied to one or more of the front wheels and in response instruct movement of one of the seat and the set of rear wheels in a first direction along the axis between the set of front wheels and the set of rear wheels, and
wherein the controller is configured to detect an increase in the load applied to one or more of the front wheels and in response instruct movement (or relative adjustment of the position) (preferably relative to the chassis) of one of the seat and the set of rear wheels in a second direction along the axis between the set of front wheels and the set of rear wheels, the second direction being opposite to the first direction.

6. The wheelchair of claim 1, wherein the one or more sensors comprise one or more pressure sensors arranged relative to the seat to detect a load applied to the seat.

7. The wheelchair of claim 1, wherein the load adjustment mechanism comprises one or more of:
a first mechanism to move (or adjust the position of) the seat relative to the chassis along the axis between the set of front wheels and the set of rear wheels; and
a second mechanism to move (or adjust the position of) the set of rear wheels relative to the chassis along the axis between the set of front wheels and the set of rear wheels.

8. The wheelchair of claim 1, wherein the seat comprises a removeable cushion that is mounted within the chassis.

9. The wheelchair of claim 7, wherein the chassis is formed as a single piece.

10. The wheelchair of claim 1, wherein the load adjustment mechanism comprises an override mechanism to prevent an adjustment of the position of the set of rear wheels relative to the seat.

11. The wheelchair of claim 1, comprising:
one or more orientation sensors to determine an orientation of the seat,
wherein the load adjustment mechanism is modulated by input from the one or more orientation sensors.

12. The wheelchair of claim 1, comprising:
a power-assist system for the set of front wheels,
wherein the power-assist system comprises at least one motor coupled to one or more of the set of front wheels,
wherein a torque applied to one or more of the set of front wheels by the at least one motor assists the manual propulsion of the wheelchair using the set of rear wheels.

13. The wheelchair of claim 12, wherein each wheel within the set of front wheels is rotatable about a steering axis perpendicular to an axis of rotation for the wheel.

14. The wheelchair of claim 13, comprising:
a directional control system to steer the wheelchair using at least the set of front wheels,
wherein the load adjustment mechanism is configured to increase a load upon the set of front wheels to enable the directional control system and the power-assist system to propel the wheelchair when a load is absent from the seat (and/or when the load upon the front wheels is below a pre-determined threshold).

15. The wheelchair of claim 12, wherein the load adjustment mechanism is configured to adjust a load upon the set of front wheels dependent on the torque applied by the power assist system.

16. A method of operating a manually propelled wheelchair comprising:
sensing a change in a centre of gravity for the wheelchair at least along an axis between a set of front wheels and a set of rear wheels, wherein the set of rear wheels are manually propelled to move the wheelchair; and
adjusting a relative position of the set of rear wheels compared to a seat of the wheelchair based on the change, the seat being configured to receive a load for the wheelchair.

17. The method of claim 16,
wherein sensing a change in a centre of gravity comprises sensing a load applied through one or more of the set of front wheels, and
wherein adjusting a relative position of the set of rear wheels compared to a seat of the wheelchair comprises moving one of the set of rear wheels and the seat of the wheelchair based on the load.

18. The method of claim 16, wherein adjusting a relative position of the set of rear wheels compared to a seat of the wheelchair comprises moving one or more axles coupled to the set of rear wheels relative to a chassis of the wheelchair.

19. A manually propelled wheelchair comprising:
a chassis to accommodate a seat;
a pair of rear wheels for manual propulsion arranged either side of the chassis;
a pair of front wheels; and
a drive system for the pair of front wheels,
wherein the drive system comprises at least one motor coupled to the pair of front wheels, and
wherein a torque applied to one or more of the set of front wheels by the at least one motor at least assists the propulsion of the wheelchair.

20. The wheelchair of claim 19, comprising:
a directional control system to adjust a direction of the wheelchair by instructing a differential torque to be applied to one or more of the set of front wheels,
wherein the drive system and the directional control system enable remote control of the wheelchair when a load is absent from the seat.

21-25. (canceled)
